(19) United States
(12) Patent Application Publication
(10) Pub. No.: US 2017/0308507 A1
(43) Pub. Date: Oct. 26, 2017

(54) IMAGE PROCESSING APPARATUS

(71) Applicant: KYOCERA Document Solutions Inc., Osaka (JP)

(72) Inventor: Kazushi SHINTANI, Osaka (JP)

(73) Assignee: KYOCERA Document Solutions Inc., Osaka (JP)

(21) Appl. No.: 15/482,209

(22) Filed: Apr. 7, 2017

(30) Foreign Application Priority Data
Apr. 20, 2016 (JP) 2016-084565
Apr. 20, 2016 (JP) 2016-084572

(51) Int. Cl. G06F 17/21; G06F 17/24; G06K 9/18; H04N 1/387; G09B 7/02; G06K 9/00

(52) U.S. Cl. CPC G06F 17/211; G09B 7/02; G06K 9/00449; G06K 9/18; H04N 1/3872; G06F 17/24; G06K 2209/011; H04N 2201/0082; H04N 2201/0094

(57) ABSTRACT

An image processing apparatus includes an input section for inputting image data, and an image processing section for discriminating a marking area out of image data and generating image data of fill-in-blank questions with the marking area converted to a blank answer field. For generation of the image data of fill-in-blank questions, the image processing section recognizes a character count of characters present in the marking area, determines, as an answer-field character count, a character count resulting from adding a margin number to the character count of the marking area, and changes a size of the answer field to a size adapted to the answer-field character count.

### INCORPORATION BY REFERENCE

This application is based upon and claims the benefit of priority from the corresponding Japanese Patent Applications No. 2016-084565 and No. 2016-084572 filed on Apr. 20, 2016, the entire contents of which are incorporated herein by reference.

### BACKGROUND

The present disclosure relates to an image processing apparatus for generating image data of fill-in-blank questions (or wormhole-like blank problems).

Conventionally, there is known a technique for reading an original (textbook etc.) serving as a base of fill-in-blank questions and, with use of image data obtained by the reading of the original, generating image data of fill-in-blank questions.

With the conventional technique, out of image data of an original serving as a base of fill-in-blank questions, an object character image (an image of a character string presented as a question to an answerer) can be converted to a blank answer field. More specifically, out of image data of an original serving as a base of fill-in-blank questions, an object character image is overlaid with blind data, so that a spot overlaid with the blind data is provided as an answer field.

### SUMMARY

An image processing apparatus in a first aspect of the present disclosure includes an input section, and an image processing section. The input section inputs image data of an original inclusive of a document to the image processing apparatus. The image processing section discriminates a marking area marked by a user out of image data of the original, and generates image data of fill-in-blank questions with the marking area converted to a blank answer field. For generation of the image data of fill-in-blank questions, the image processing section performs a character recognition process for character recognition of the marking area to recognize a character count of characters present in the marking area, determines, as an answer-field character count, a character count resulting from adding a margin number to the character count of the marking area, and changes a size of the answer field in a first direction, which is a direction in which writing of the document progresses, to a size adapted to the answer-field character count.

An image processing apparatus in a second aspect of the disclosure includes an input section, and an image processing section. The input section inputs image data of an original inclusive of a document to the image processing apparatus. The image processing section discriminates a marking area marked by a user out of image data of the original, and generates image data of fill-in-blank questions with the marking area converted to a blank answer field. For generation of the image data of fill-in-blank questions, the image processing section performs a labeling process for the marking area to determine a number of pixel blocks that are blocks of pixels having a pixel value equal to or higher than a predetermined threshold, and moreover recognizes the determined number of pixel blocks as a character count of the marking area, determines, as an answer-field character count, a character count resulting from adding a margin number to the character count of the marking area, and changes a size of the answer field in a first direction, which is a direction in which writing of the document progresses, to a size adapted to the answer-field character count.

### BRIEF DESCRIPTION OF THE DRAWINGS

FIG. 1 is a view showing a multifunction peripheral according to an embodiment of the disclosure;

FIG. 2 is a diagram showing a hardware configuration of the multifunction peripheral according to one embodiment of the disclosure;

FIG. 3 is a view for explaining a labeling process;

FIG. 4 is a view showing an example of a setting screen (screen for making settings related to a fill-in-blank question preparation mode) to be displayed on an operation panel of the multifunction peripheral according to one embodiment of the disclosure;

FIG. 5 is a view showing an example of image data of an original serving as a base of fill-in-blank questions to be generated by the multifunction peripheral according to one embodiment of the disclosure;

FIG. 6 is a view for explaining a process to be executed for generating image data of fill-in-blank questions by the multifunction peripheral according to one embodiment of the disclosure;

FIG. 7 is a view for explaining a process to be executed for generating image data of fill-in-blank questions by the multifunction peripheral according to one embodiment of the disclosure;

FIG. 8 is a view showing an example of image data of fill-in-blank questions to be generated by the multifunction peripheral according to one embodiment of the disclosure;

FIG. 9 is a view for explaining an answer-field enlargement process to be executed for generating image data of fill-in-blank questions by the multifunction peripheral according to one embodiment of the disclosure;

FIG. 10 is a view for explaining an image moving process to be executed for generating image data of fill-in-blank questions by the multifunction peripheral according to one embodiment of the disclosure;

FIG. 11 is a view for explaining an image moving process to be executed for generating image data of fill-in-blank questions by the multifunction peripheral according to one embodiment of the disclosure;

FIG. 12 is a view showing an example of image data of fill-in-blank questions to be generated by the multifunction peripheral according to one embodiment of the disclosure;

FIG. 13 is a flowchart for explaining a flow of processing to be executed for generating image data of fill-in-blank questions by the multifunction peripheral according to one embodiment of the disclosure;

FIG. 14 is a view showing an example of image data of fill-in-blank questions to be generated by the multifunction peripheral according to one embodiment of the disclosure; and

FIG. 15 is a flowchart for explaining a flow of processing to be executed for generating image data of fill-in-blank questions by the multifunction peripheral according to one embodiment of the disclosure.

### DETAILED DESCRIPTION

Hereinbelow, an image processing apparatus according to one embodiment of the present disclosure will be described by taking as an example a multifunction peripheral (image processing apparatus) on which plural types of functions such as copying function are mounted.

### General Configuration of Multifunction Peripheral

### Common to First and Second Embodiments

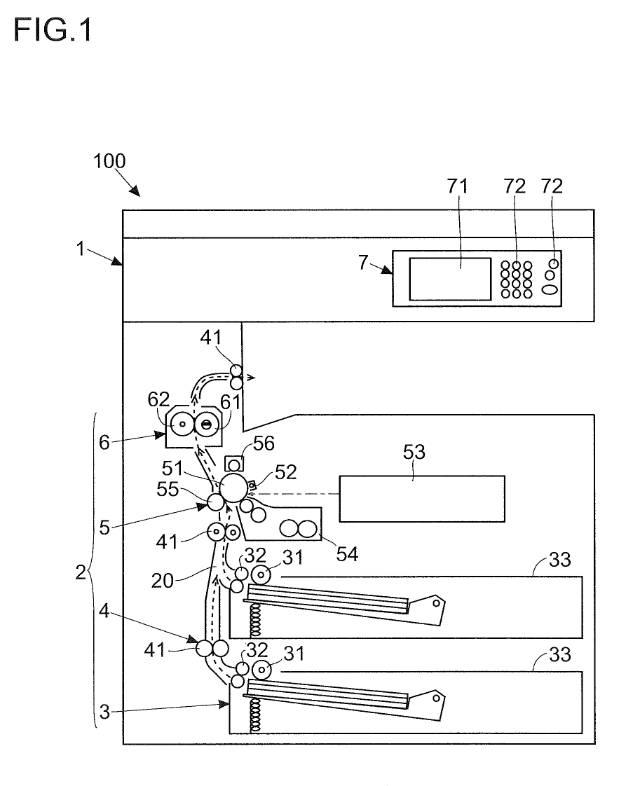

As shown in FIG. 1, a multifunction peripheral 100 of this embodiment includes an image reading section 1 and a printing section 2. The image reading section 1 reads an original and generates image data of the original. The printing section 2, while conveying a paper sheet along a sheet conveyance path 20, forms a toner image on a basis of the image data. Then, the printing section 2 transfers (prints) the toner image onto the sheet under conveyance.

The printing section 2 is composed of a sheet feed part 3, a sheet conveyance part 4, an image forming part 5, and a fixing part 6. The sheet feed part 3 includes a pickup roller 31 and a sheet feed roller pair 32 to feed a paper sheet set in a sheet cassette 33 onto the sheet conveyance path 20. The sheet conveyance part 4 includes a plurality of conveyance roller pairs 41 to convey the sheet along the sheet conveyance path 20.

The image forming part 5 includes a photosensitive drum 51, a charging unit 52, an exposure unit 53, a developing unit 54, a transfer roller 55, and a cleaning unit 56. The image forming part 5 forms a toner image on a basis of image data and transfers the toner image onto the sheet. The fixing part 6 includes a heating roller 61 and a pressure roller 62 to heat and pressurize, thereby fix, the toner image transferred on the sheet.

The multifunction peripheral 100 also includes an operation panel 7. The operation panel 7 is provided with a touch panel display 71. For example, the touch panel display 71 displays software keys for accepting various types of settings to accept various types of settings from a user (accept touch operations applied to the software keys). The operation panel 7 is also provided with hardware keys 72 such as a start key and ten keys.

### Hardware Configuration of Multifunction Peripheral

### Common to First and Second Embodiments

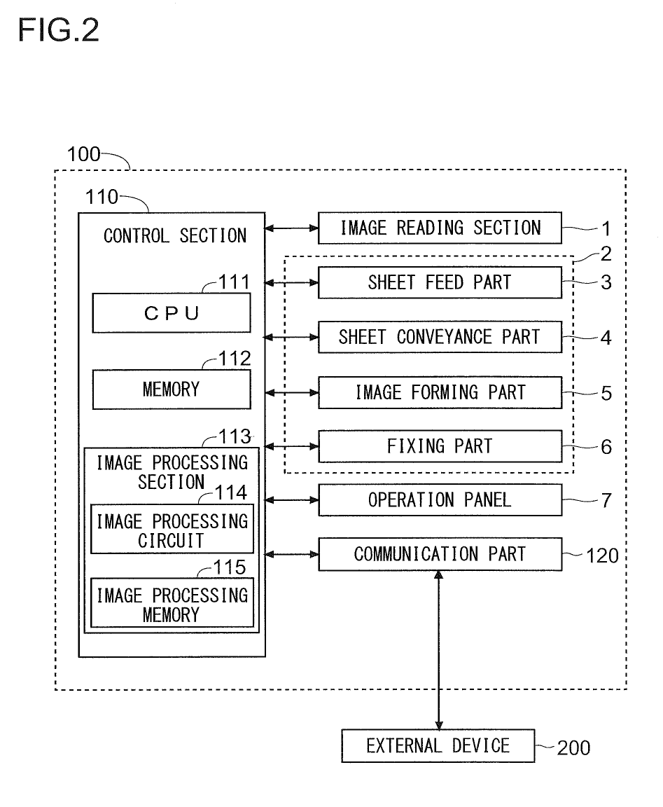

As shown in FIG. 2, the multifunction peripheral 100 includes a control section 110. The control section 110 includes a CPU 111, a memory 112 and an image processing section 113. The CPU 111 operates based on control-dedicated programs and data. The memory 112 includes ROM and RAM. Control-dedicated programs and data for operating the CPU 111 are stored in the ROM and loaded on the RAM. Then, based on the control-dedicated programs and data, the control section 110 (CPU 111) controls operations of the image reading section 1 and the printing section 2 (sheet feed part 3, sheet conveyance part 4, image forming part 5 and fixing part 6). Also the control section 110 controls operation of the operation panel 7.

The image processing section 113 includes an image processing circuit 114 and an image processing memory 115. Then the image processing section 113 performs, on image data, various types of image processing such as scale-up/scale-down, density conversion and data format conversion.

In this case, the image processing section 113 performs a character recognition process, i.e., a process for recognizing characters or character strings included in image data inputted to the multifunction peripheral 100. For the character recognition process by the image processing section 113, for example, an OCR (Optical Character Recognition) technique is used.

In order that the image processing section 113 is allowed to execute the character recognition process, for example, a character database containing character patterns (standard patterns) for use of pattern matching is preparatorily stored in the image processing memory 115. Then, in executing a character recognition process, the image processing section 113 extracts a character image out of processing-object image data. In this operation, the image processing section 113 performs layout analysis or the like for the processing-object image data to specifically determine a character area, and then cuts out (extracts) character images on a character-by-character basis out of the character area. Thereafter, the image processing section 113 performs a process of making a comparison (matching process) between character patterns stored in the character database and the extracted character images to recognize characters on a basis of a result of the comparison. In addition, in the character database, character patterns for use of pattern matching are stored as they are categorized into individual character types such as kanji characters (Chinese characters), hiragana characters (Japanese cursive characters), katakana (Japanese phonetic characters for representation of foreign characters etc.), and alphabetic characters.

The image processing section 113 also binarizes image data by a predetermined threshold and performs a labeling process on binarized image data. In executing the labeling process, the image processing section 113 raster scans binarized image data to search for pixels having a pixel value equal to or higher than the threshold. In addition, the threshold to be used for the binarization of image data may be arbitrarily changed.

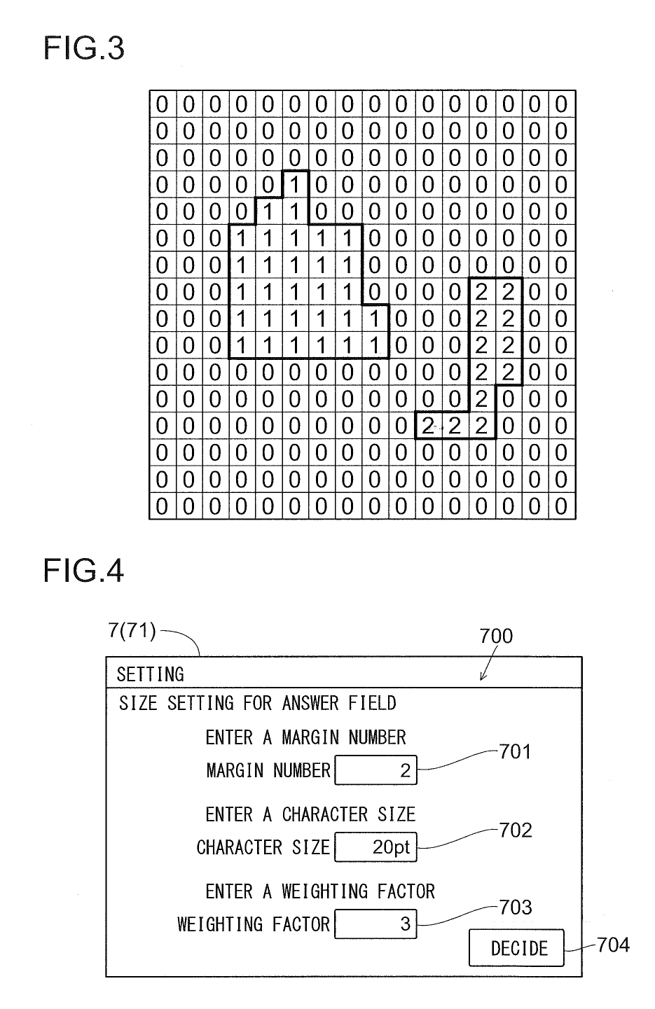

Then, as shown in FIG. 3, the image processing section 113 assigns label numbers to individual blocks of pixels (pixel blocks) each having a pixel value of the threshold or more (assigns an identical label number to each of pixels constituting one identical pixel block). As a result, the number of pixel blocks present in image data can be determined based on the label count of the assignment to the individual pixel blocks. In FIG. 3, one square corresponds to one pixel, and numbers assigned to the pixels are shown in the squares, respectively. Each pixel block is surrounded by bold line.

Reverting to FIG. 2, the control section 110 is connected to a communication part 120. The communication part 120 is communicatably connected to an external device 200. For example, a personal computer (PC) to be used by a user is connected via LAN to the communication part 120. As a result, image data generated by the multifunction peripheral 100 can be transmitted to the external device 200. Otherwise, data transmission from the external device 200 to the multifunction peripheral 100 is also enabled.

### Preparation of Fill-in-Blank Questions

### Common to First and Second Embodiments

The multifunction peripheral 100 of this embodiment is equipped with a fill-in-blank question preparation mode for preparing fill-in-blank questions presented as partly blanked answer fields in a document. For preparation of fill-in-blank questions with use of the fill-in-blank question preparation mode, an original serving as a base of fill-in-blank questions is prepared and portions out of the original document to be transformed into blank answer fields are marked with fluorescent pen or the like by the user. Then, various types of settings related to the fill-in-blank question preparation mode are made on the multifunction peripheral 100.

For example, when a predetermined operation for transition to the fill-in-blank question preparation mode is effected on the operation panel 7, the control section 110 makes a transition to the fill-in-blank question preparation mode. When this occurs, the control section 110 instructs the operation panel 7 to display thereon a setting screen 700 (see FIG. 4) for accepting various types of settings related to the fill-in-blank question preparation mode. In this setting screen 700, for example, settings related to the size of answer fields for fill-in-blank questions (setting of margin number, setting of character size, setting of weighting factor, etc.) can be fulfilled.

In the setting screen 700, as shown in FIG. 4, input fields 701, 702 and 703 are disposed. The input field 701 is a field in which a margin number set by the user is entered. The input field 702 is a field in which a character size set by the user is entered. The input field 703 is a field in which a weighting factor set by the user is entered.

For example, touching the input field 701 causes the margin number to be a setting object, in which state entering a numerical value by using the ten keys of the operation panel 7 allows the entered numerical value to be set as a margin number (the entered numerical value is expressed in the input field 701). Also, touching the input field 702 causes the character size to be a setting object, in which state entering a numerical value by using the ten keys of the operation panel 7 allows the entered numerical value to be set as a character size (the entered numerical value is expressed in the input field 702). Further, touching the input field 703 causes the weighting factor to be a setting object, in which state entering a numerical value by using the ten keys of the operation panel 7 allows the entered numerical value to be set as a weighting factor (the entered numerical value is expressed in the input field 703). With this constitution, the operation panel 7 corresponds to ‘accepting part’.

As will be detailed later, the larger the set value for the margin number is made, the larger the size of the answer field in its character-writing direction (the direction in which characters go on being written ahead) can be made. Also, the larger the set value for the character size is made, the larger the size of the answer field in its character-writing direction can be made and moreover the larger the size of the answer field in a direction perpendicular to its character-writing direction can be made. Further, the larger the set value for the weighting factor is made, the larger the size of the answer field in its character-writing direction can be made.

Also in the setting screen 700, a decision key 704 is provided. Upon detection of a touch operation on the decision key 704, the control section 110 definitely establishes a numerical value entered in the input field 701 as the margin number, establishes a numerical value entered in the input field 702 as the character size, and establishes a numerical value entered in the input field 703 as the weighting factor. Then, the control section 110 instructs the operation panel 7 to execute a notification for prompting the user to input image data of an original serving as the base of fill-in-blank questions (an original with marking applied to portions in a document) to the multifunction peripheral 100. Hereinafter, image data of an original serving as the base of fill-in-blank questions will in some cases be referred to as ‘object image data’).

Input of object image data to the multifunction peripheral 100 can be implemented by reading an original serving as the base of fill-in-blank questions with the image reading section 1. With this constitution, the image reading section 1 corresponds to ‘input section’. Otherwise, object image data can also be inputted to the multifunction peripheral 100 via the communication part 120. With this constitution, the communication part 120 corresponds to ‘input section’.

Upon input of object image data to the multifunction peripheral 100, the control section 110 transfers the object image data to the image processing memory 115 of the image processing section 113. The control section 110 also gives the image processing section 113 a preparation command for image data of fill-in-blank questions. The image processing section 113, having received this command, generates image data of fill-in-blank questions by using the object image data stored in the image processing memory 115.

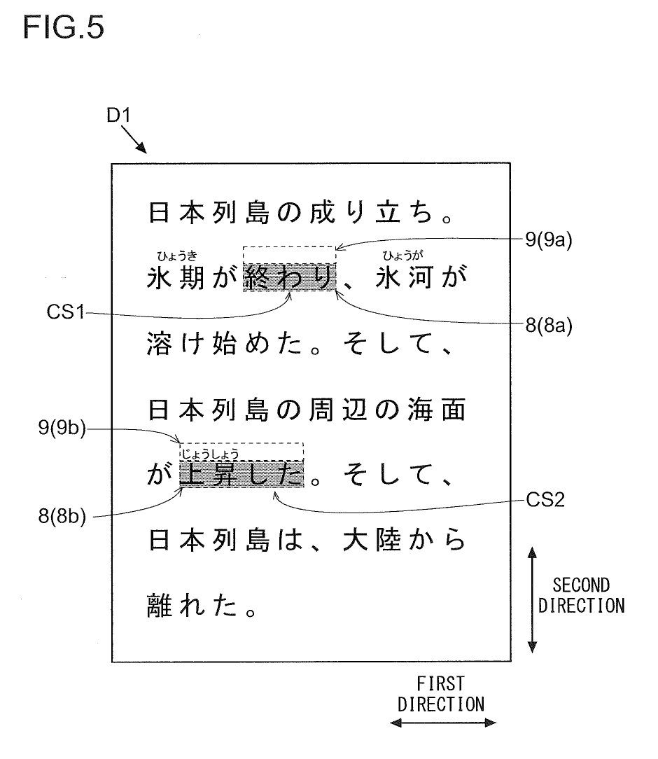

Hereinbelow, the generation of image data of fill-in-blank questions to be fulfilled by the image processing section 113 will be described on an example in which such object image data D1 as shown in FIG. 5 is inputted to the multifunction peripheral 100. In FIG. 5, areas marked by the user are designated by reference sign 8. In the following description, an area depicted with marking will be referred to as marking area 8. Also, a character-writing direction (row direction) of the document will be referred to as first direction, and a direction perpendicular to the first direction will be referred to as second direction. In this case, with the document in horizontal writing (see FIG. 5), the character-writing direction is a left-right direction. On the other hand, with the document in vertical writing (not shown), the character-writing direction is an up-down direction.

### First Embodiment

In a first embodiment, for generation of image data of fill-in-blank questions, the image processing section 113 discriminates a marking area 8 present in the object image data Dl. The discrimination of the marking area 8 is fulfilled based on pixel values (density values) of individual pixels in the object image data Dl. Although not particularly limited, the discrimination process may include searching for pixel strings composed of pixels higher in density than pixels of the background image, and discriminating, as a marking area 8, an area in which the pixel string continuously extends in a direction perpendicular to the column direction.

After the discrimination of the marking area 8, the image processing section 113 performs a character recognition process on the marking area 8. By this process, the image processing section 113 recognizes a character count that is a number of characters present in the marking area 8. Further, the image processing section 113 recognizes the types of characters (kanji, hiragana, katakana, alphabet, etc.) present in the marking area 8 and classifies the characters of the marking area 8 into kanji characters and non-kanji characters. The term, non-kanji characters, refers to characters other than kanji characters, where hiragana, katakana, alphabet characters and the like are classified into non-kanji characters.

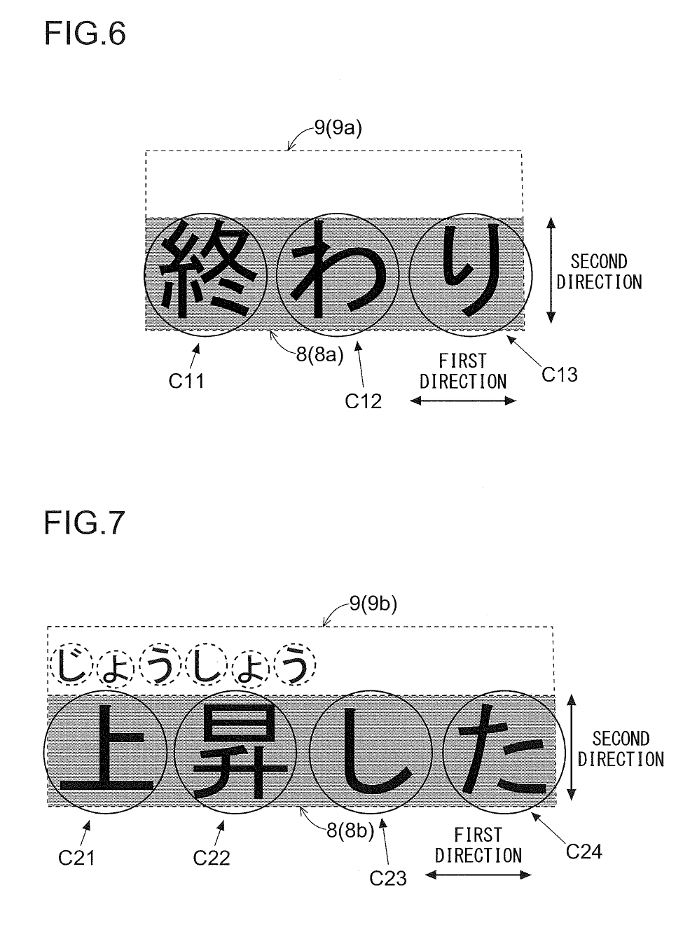

For example, when the character recognition process for a marking area 8 inclusive of a character string CS1 (hereinafter, referred to as marking area 8a) is executed by the image processing section 113 in the example shown in FIG. 5, individual character images present in a plurality of areas encircled by solid-line circular frames are recognized as characters, respectively, as shown in FIG. 6. The individual characters are designated by signs C11, C12 and C13, respectively. Out of the characters C11, C12 and C13 of the marking area 8a, the image processing section 113 recognizes the character C11 as a kanji character and the characters C12 and C13 as hiragana characters. That is, the characters C11, C12 and C13 of the marking area 8a are classified into a kanji character and non-kanji characters. As a consequence, the image processing section 113 recognizes that the character count of the marking area 8a is ‘3’, among which the kanji-character count is ‘1’ and the non-kanji character count is ‘2’.

Also, when the character recognition process for the marking area 8 inclusive of a character string CS2 (hereinafter, referred to as marking area 8b) is executed by the image processing section 113 in the example shown in FIG. 5, individual character images present in a plurality of areas encircled by solid-line circular frames are recognized as characters, respectively, as shown in FIG. 7. The individual characters are designated by signs C21, C22, C23 and C24, respectively. Out of the characters C21, C22, C23 and C24 of the marking area 8b, the image processing section 113 recognizes the characters C21 and C22 as kanji characters and the characters C23 and C24 as hiragana characters. That is, the characters C21, C22, C23 and C24 of the marking area 8b are classified into kanji characters and non-kanji characters. As a consequence, the image processing section 113 recognizes that the character count of the marking area 8b is ‘4’, among which the kanji-character count is ‘2’ and the non-kanji character count is ‘2’.

Further, the image processing section 113 classifies the kanji characters of the marking areas 8 into kana-added kanji characters (kanji characters with phonetic-aid kana characters added thereto) and no-kana-added kanji characters (kanji characters with no phonetic-aid kana characters added thereto). In the case of horizontal writing, generally, kana characters added to kanji characters are placed upward of the kanji characters. In the case of vertical writing, kana characters added to kanji characters are placed rightward of the kanji characters.

Then, for an adjacent-to-marking area 9, which is one (upper-side one) of both-side areas of a marking area 8 in the second direction and which is adjacent to the marking area 8, the image processing section 113 performs a character recognition process similar to the character recognition process performed for the marking areas 8 (i.e., the image processing section 113 recognizes character count and character type of characters present in the adjacent-to-marking area 9). As a consequence, the image processing section 113 recognizes kana characters added to the kanji characters of the marking area 8.

More specifically, the image processing section 113 sets, as an adjacent-to-marking area 9, a range from a second-direction end position of the marking area 8 to a position separated therefrom by a predetermined number of pixels in the second direction (upward direction). Then, when a character is present in the adjacent-to-marking area 9 as a result of the character recognition process performed for the adjacent-to-marking area 9, the image processing section 113 recognizes the character as a kana character.

When a kana character is present in the adjacent-to-marking area 9, the image processing section 113 specifically determines a kana-added kanji character out of the kanji characters in the marking area 8. For example, the image processing section 113 determines, out of the kanji characters of the marking area 8, a kanji character present under the kana character of the adjacent-to-marking area 9 as a kana-added kanji character. On the other hand, out of the kanji characters of the marking area 8, the image processing section 113 determines kanji characters with no kana characters present upward thereof, as no-kana-added kanji characters. Furthermore, the image processing section 113 determines individual character counts of kana-added kanji characters and no-kana-added kanji characters, respectively, present in the marking area 8 as well as determines a kana-character count (kana count) present in the adjacent-to-marking area 9.

For instance, in the examples shown in FIGS. 6 and 7, in which the document is in horizontal writing, the upper-side area of the marking area 8 is set as the adjacent-to-marking area 9. Hereinafter, an adjacent-to-marking area 9 corresponding to the marking area 8a will be designated by sign 9a, and an adjacent-to-marking area 9 corresponding to the marking area 8b will be designated by sign 9b.

In the example shown in FIG. 6, no characters are present in the adjacent-to-marking area 9a. Accordingly, as a result of executing the character recognition process for the adjacent-to-marking area 9a, the image processing section 113 decides that no kana characters are present in the adjacent-to-marking area 9a (i.e., the image processing section 113 recognizes the kana count of the adjacent-to-marking area 9a as ‘0’). In this case, the image processing section 113 classifies the character C11 (kanji character) present in the marking area 8a into no-kana-added kanji characters.

In the example shown in FIG. 7, characters are present in the adjacent-to-marking area 9b. Accordingly, as a result of executing the character recognition process for the adjacent-to-marking area 9b, the image processing section 113 decides that kana characters are present in the adjacent-to-marking area 9b (i.e., the image processing section 113 recognizes the kana count of the adjacent-to-marking area 9b as ‘6’). In FIG. 7, kana characters recognized in the adjacent-to-marking area 9b by the image processing section 113 are encircled by broken-line circular frames, respectively.

Also, the character C21 (kanji character) and the character C22 (kanji character) are present under the kana characters (characters encircled by broken-line circular frames) of the adjacent-to-marking area 9b. Therefore, the image processing section 113 classifies the character C21 (kanji character) and the character C22 (kanji character) into kana-added kanji characters. In addition, no-kana-added kanji characters are absent in the marking area 8b.

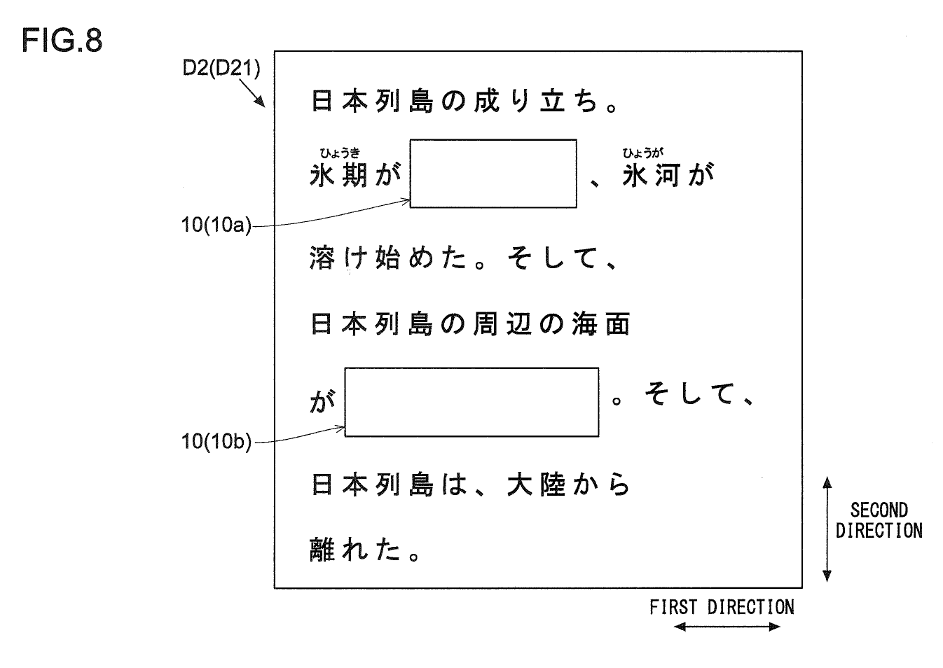

After executing the character recognition process for the marking area 8 and the adjacent-to-marking area 9 (after recognizing character counts of the individual areas, respectively), the image processing section 113 generates such image data D2 (D21) of fill-in-blank questions as shown in FIG. 8. The image data D21 of fill-in-blank questions is image data in which the marking areas 8 of the object image data D1 shown in FIG. 5 have been converted to blank answer fields 10. More specifically, the images of the marking areas 8 are erased and internally-blanked frame images are inserted instead. In this process, the images of the adjacent-to-marking areas 9 are also erased. Hereinafter, an answer field 10 corresponding to the marking area 8a will be designated by sign 10a, and an answer field 10 corresponding to the marking area 8b will be designated by sign 10b.

For generation of the image data D21 of fill-in-blank questions, the image processing section 113 determines an answer-field character count resulting from adding a margin to a predicted character count that could be entered into an answer field 10. The answer-field character count, which serves as a reference for determining the size of the answer field 10, is determined on a basis of character count and character type of characters in the marking area 8, character count (kana count) of characters of the adjacent-to-marking area 9, and set values (margin number, character size and weighting factor) set in the setting screen 700 (see FIG. 4) by the user.

More specifically, the image processing section 113 sums up a kana count of kana characters added to kana-added kanji characters in a marking area 8 (a character count of characters in the adjacent-to-marking area 9), a character count resulting from multiplying the character count of no-kana-added kanji characters in the marking area 8 by the weighting factor, and a character count of non-kanji characters in the marking area 8, and then adds the margin number to the summed-up total value to determine the resulting character count as an answer-field character count. It is noted that the resulting answer-field character count does not include the character count of kana-added kanji characters (count of kana-added kanji characters) in the marking area 8.

For example, it is assumed that the margin number is set to ‘2’ and the weighting factor is set to ‘3’ in the setting screen 700 (see FIG. 4).

In this case, in the example shown in FIG. 6, kana-added kanji characters are absent, and a character C11 that is a no-kana-added kanji character as well as characters C12 and C13 that are non-kanji characters are present. That is, the kana count of kana-added kanji characters is ‘0’. The character count of no-kana-added kanji characters is ‘1’, and a character count resulting from multiplying the character count of no-kana-added kanji characters by the weighting factor is ‘3(=1×3)’. Further, the character count of non-kanji characters is ‘2’. As a consequence, the answer-field character count of the answer field 10a corresponding to the marking area 8a results in ‘7(=0+3+2+2)’.

In the example shown in FIG. 7, whereas the characters C21 and C22 that are kana-added kanji characters are present, no-kana-added kanji characters are absent, and characters C23 and C24 that are non-kanji characters are present. Further, a total of six kana characters (characters encircled by broken-line circular frames) are added to the kana-added kanji characters. That is, the kana count of kana-added kanji characters is ‘6’. The character count of no-kana-added kanji characters is ‘0’. Further, the character count of non-kanji characters is ‘2’. As a consequence, the answer-field character count of the answer field 10b corresponding to the marking area 8b results in ‘10(=6+0+2+2)’.

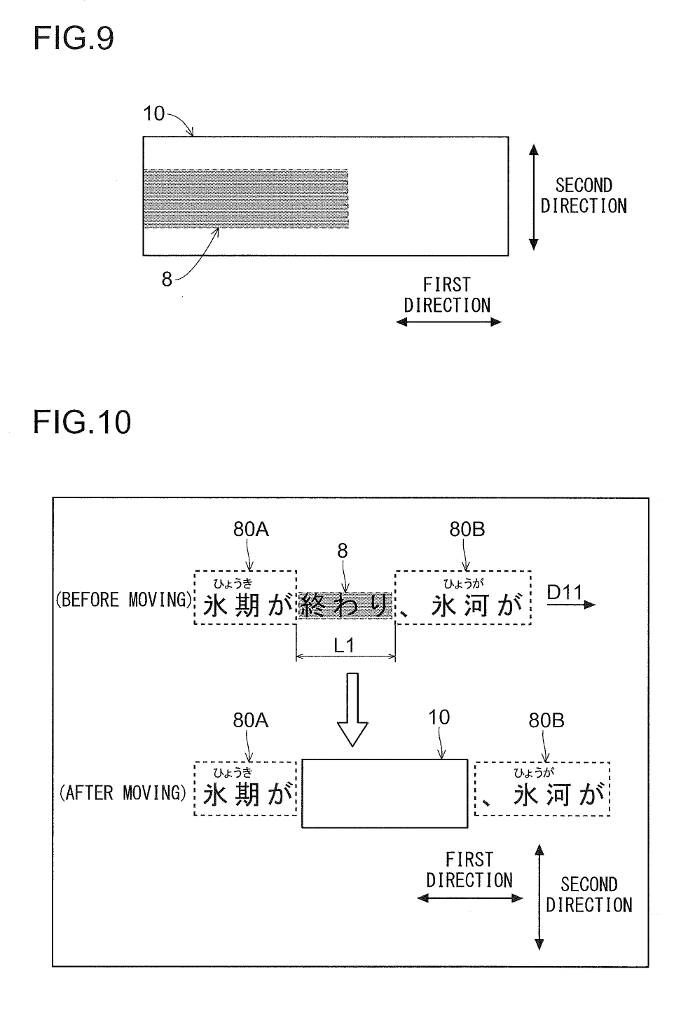

Then, as shown in FIG. 9, in converting the marking area 8 to the answer field 10, the image processing section 113 makes the first-direction size of the answer field 10 larger than the first-direction size of the marking area 8. Further, the image processing section 113 makes the second-direction size of the answer field 10 larger than the second-direction size of the marking area 8.

First, the first-direction size of the answer field 10 is changed to a size adapted to the answer-field character count. For example, the image processing section 113 divides the first-direction size of the marking area 8 by the character count of the marking area 8 to determine a first value (first-direction size per character), and then multiplies the first value by the answer-field character count to determine a second value, which is taken as the first-direction size of the answer field 10. As a consequence, the first-direction size of the answer field 10 is made larger than the first-direction size of the marking area 8.

Otherwise, when the widthwise size per character set in the setting screen 700 (see FIG. 4) is larger than the first value, the image processing section 113 multiplies the widthwise size per character, which has been set in the setting screen 700, by the answer-field character count and assumes the resulting value as the first-direction size of the answer field 10. In this case, the larger the widthwise size per character set in the setting screen 700 is, the larger the first-direction size of the answer field 10 becomes.

In addition, the type of characters to be entered on a paper sheet of fill-in-blank questions varies from answerers who enter an answer all in hiragana (katakana) characters to answerers who enter an answer in combination of hiragana characters and kanji characters. For example, entering answers only in hiragana characters involves larger character counts than entering answers in combination of hiragana characters and kanji characters. Accordingly, it is preferable that the first-direction size of the answer field 10 be changed to one larger than the first-direction size of its corresponding marking area 8.

In this case, even without multiplying the character count of no-kana-added kanji characters by the weighting factor, the answer-field character count results in a count larger than the character count of the marking area 8. For example, without multiplying the character count of no-kana-added kanji characters by the weighting factor in the example shown in FIG. 6, the answer-field character count results in ‘5(=0+1+2+2)’, which is larger than the character count (‘3’ in this case) of the marking area 8a.

Furthermore, only by adding the margin number to the character count of the marking area 8 (even without considering the kana count), the answer-field character count results in a count larger than the character count of the marking area 8. For example, by executing a process of only adding the margin number to the character count of the marking area 8a in the example shown in FIG. 6, in which the character count of the marking area 8a is ‘3’, the answer-field character count results in ‘5(=3+2)’, which is larger than the character count of the marking area 8a. Also, by executing a process of only adding the margin number to the character count of the marking area 8b in the example shown in FIG. 7, in which the character count of the marking area 8b is ‘4’, the answer-field character count results in ‘6(=4+2)’, which is larger than the character count of the marking area 8b.

Therefore, it is allowable that a kana count of kana-added kanji characters in the marking area 8 (character count of characters in the adjacent-to-marking area 9), a character count of no-kana-added kanji characters (without weighting) in the marking area 8, and a character count of non-kanji characters in the marking area 8 are summed up and then the margin number is added to the summed-up total value so that the resulting character count is determined as an answer-field character count. Otherwise, a character count resulting from adding the margin number to the character count of the marking area 8 may be determined as an answer-field character count. In other words, the answer-field character count is a character count resulting from summing up the character count of kana-added kanji characters (not the kana count) in the marking area 8, the character count of no-kana-added kanji characters (without weighting) in the marking area 8, and the character count of non-kanji characters in the marking area 8 and then adding the margin number to the summed-up total value.

Next, the second-direction size of the answer field 10 is changed to a size adapted to a heightwise size per character set in the setting screen 700 (see FIG. 4). For example, the image processing section 113 assumes a heightwise size per character set in the setting screen 700 as the second-direction size of the answer field 10. As a consequence of this, the larger the heightwise size per character set in the setting screen 700 is made, the larger the second-direction size of the answer field 10 becomes. In addition, an excessively small heightwise size per character set in the setting screen 700 may cause the second-direction size of the answer field 10 to become smaller than the second-direction size of the marking area 8. In this case, the setting in the setting screen 700 may be canceled and the second-direction size of the answer field 10 may be made larger than the second-direction size of the marking area 8.

For conversion of the marking area 8 to the answer field 10, as shown in FIG. 10, in order that a first image 80A and a second image 80B present at preceding and succeeding places of the marking area 8 in the first direction are prevented from overlapping with the answer field 10, the image processing section 113 enlarges a distance L1 between the first image 80A and the second image 80B. As an example, the image processing section 113 moves the second image 80B in a direction D11 in which the second image 80B goes farther from the marking area 8.

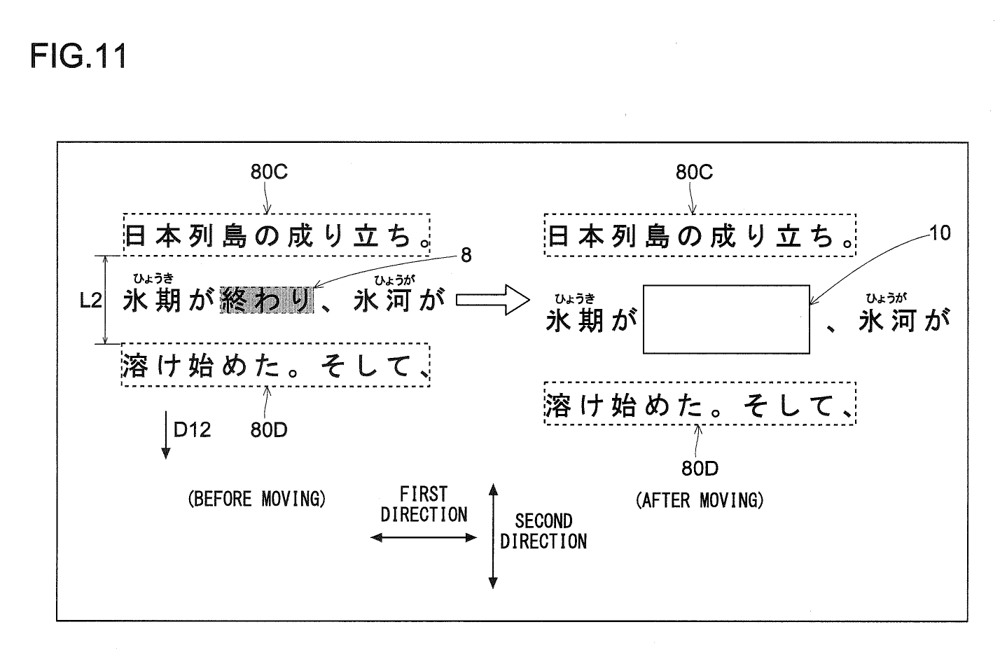

Further, as shown in FIG. 11, in order that a third image 80C and a fourth image 80D present at preceding and succeeding places of the marking area 8 in the second direction are prevented from overlapping with the answer field 10, the image processing section 113 enlarges a distance L2 between the third image 80C and the fourth image 80D. As an example, the image processing section 113 moves an entire row inclusive of the fourth image 80D in a direction D12 in which the row goes farther from the marking area 8. Then, the image processing section 113 places an entire row inclusive of the marking area 8 at a second-direction intermediate position between a row inclusive of the third image 80C and the row inclusive of the fourth image 80D (i.e., moves the entire row inclusive of the marking area 8 in the direction D12 in which the row goes farther from the third image 80C).

As a result of this, such image data D21 of fill-in-blank questions as shown in FIG. 8 is generated. The image data D21 of fill-in-blank questions is outputted to the printing section 2. The image data D21 of fill-in-blank questions outputted to the printing section 2 is converted to exposure control-dedicated data for controlling the exposure unit 53. Then, the printing section 2 prints out the fill-in-blank questions onto the paper sheet on the basis of the image data D2 of fill-in-blank questions (exposure control-dedicated data).

In addition, as shown in FIGS. 10 and 11, the second image 80B present at the first-direction succeeding place of the marking area 8 is shifted in the direction D11, and a row inclusive of the marking area 8 as well as another row present at the second-direction succeeding place of the row are shifted in the direction D12. Due to this, the sheet size of the paper sheet on which the fill-in-blank questions are printed out becomes larger than the original format size of the original serving as the base of the fill-in-blank questions.

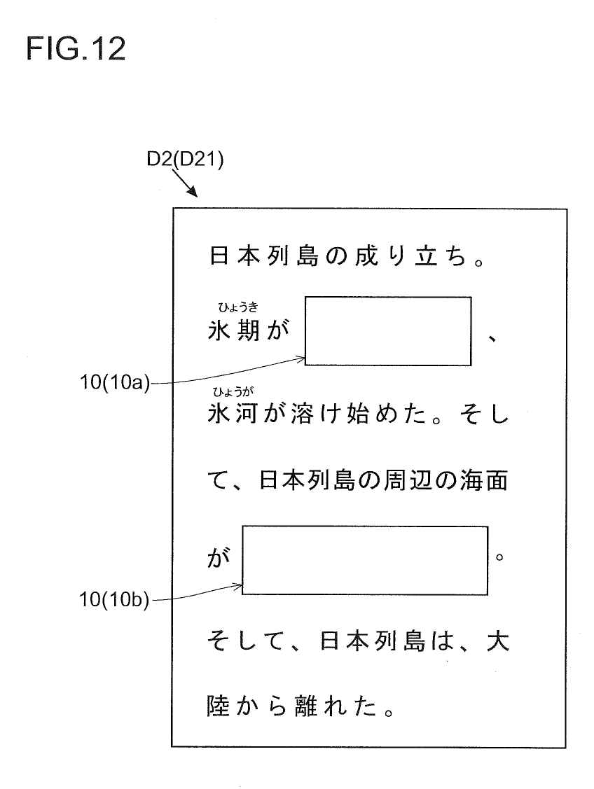

In this case, the image data D21 of fill-in-blank questions may be converted to a predetermined document format. Then, as shown in FIG. 12, individual line-feed positions in the document inclusive of the fill-in-blank questions may be aligned to one another.

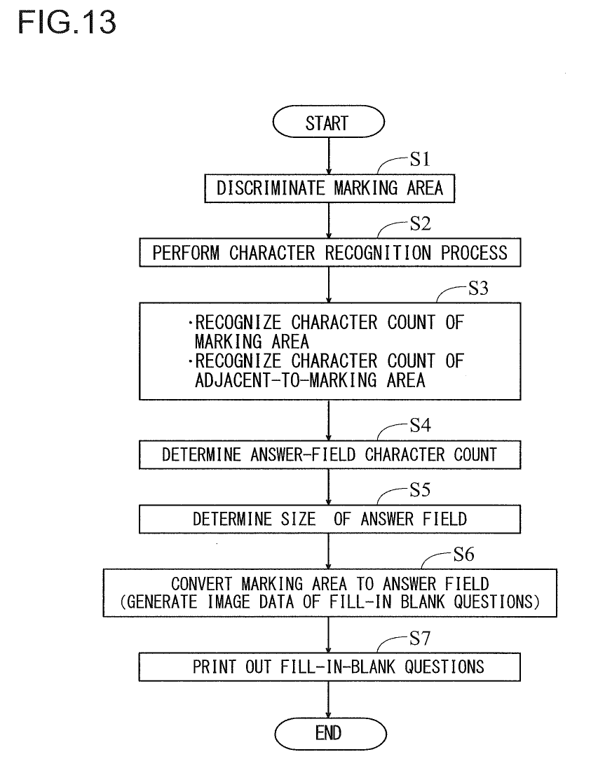

Hereinbelow, a processing flow for generation of the image data D21 of fill-in-blank questions will be described with reference to the flowchart shown in FIG. 13. With object image data D1 (image data of an original serving as a base of fill-in-blank questions) transferred to the image processing section 113, when the control section 110 has issued a command for preparation of image data D21 of fill-in-blank questions to the image processing section 113, the flowchart shown in FIG. 13 gets started.

At step S1, the image processing section 113 discriminates a marking area 8 out of the object image data D1. Subsequently at step S2, the image processing section 113 performs a character recognition process for the marking area 8 and an adjacent-to-marking area 9. Then, at step S3, the image processing section 113 recognizes character counts (individual character counts of kana-added kanji characters, no-kana-added kanji characters and non-kanji characters) of the marking area 8, and also recognizes a character count (kana count) of the adjacent-to-marking area 9.

At step S4, the image processing section 113 sums up the kana count of kana characters added to kana-added kanji characters of the marking area 8 (character count of characters of the adjacent-to-marking area 9), a character count resulting from multiplying the character count of no-kana-added kanji characters of the marking area 8 by the weighting factor, and the character count of non-kanji characters of the marking area 8, and then adds the margin number to the summed-up total value to determine the resulting character count as an answer-field character count. Thereafter, at step S5, the image processing section 113 determines a size of the answer field 10 on a basis of the answer-field character count and the character size set in the setting screen 700 (see FIG. 4).

At step S6, the image processing section 113 converts the marking area 8 of the object image data D1 to the answer field 10. Thus, image data D21 of fill-in-blank questions is generated. Then, at step S7, the image processing section 113 outputs the image data D21 of fill-in-blank questions (exposure control-dedicated data) to the printing section 2. The printing section 2, having received the image data D21, prints out the fill-in-blank questions on a sheet and delivers the sheet.

In the first embodiment, the first-direction size of the answer field 10 is changed to a size adapted to the answer-field character count. In this case, since the answer-field character count is a character count resulting from adding the margin number to the character count of the marking area 8, the answer-field character count becomes larger than the character count of the marking area 8. Therefore, the first-direction size of the answer field 10, when changed to a size adapted to the answer-field character count, becomes larger than the first-direction size of the marking area 8. In other words, the first-direction size of the answer field 10 never becomes equal to or smaller than the first-direction size of the marking area 8. As a result of this, there can be suppressed occurrence of a disadvantage that characters can hardly be entered into the answer field 10 due to an excessively small size of the answer field 10 on the fill-in-blank question sheet printed on a basis of the fill-in-blank question image data D2.

Also in the first embodiment, as described above, the image processing section 113 classifies characters of the marking area 8 into kanji characters and non-kanji characters, and moreover performs the character recognition process for an adjacent-to-marking area 9 which is one of both-side areas of the marking area 8 in the second direction perpendicular to the first direction and which is adjacent to the marking area 8. By this process, the image processing section 113 recognizes kana characters added to kanji characters of the marking area 8, by which the image processing section 113 further classifies kanji characters of the marking area 8 into kana-added kanji characters and no-kana-added kanji characters. Then, the image processing section 113 adds the margin number to a total sum of a kana count of kana characters added to the kana-added kanji characters, a character count of no-kana-added kanji characters, and a character count of non-kanji characters to determine the resulting character count as an answer-field character count. With this constitution, when kana-added kanji characters are marked, a character count of the kana-added kanji characters is taken as the character count of kana characters added to the relevant kanji characters. As a result, the first-direction size of the answer field 10 becomes even larger. Thus, there can be suppressed occurrence of a disadvantage that the answer field 10 lacks entry space for entry of hiragana characters corresponding to kana-added kanji characters.

Also in the first embodiment, as described above, for determination of the answer-field character count, the image processing section 113 multiplies a character count of no-kana-added kanji characters by a predetermined weighting factor. With this constitution, when no-kana-added kanji characters are marked, the character count of no-kana-added kanji characters is multiplied by the weighting factor. As a result, the first-direction size of the answer field 10 becomes even larger. Thus, there can be suppressed occurrence of a disadvantage that the answer field 10 lacks entry space for entry of hiragana characters corresponding to no-kana-added kanji characters.

Also in the first embodiment, as described above, for determination of the answer-field character count, the image processing section 113 multiplies a character count of no-kana-added kanji characters by a weighting factor accepted by the operation panel 7. With this constitution, since the first-direction size adjustment (change in weighting factor) of the answer field 10 can be easily done, convenience for question-preparing persons is improved. For example, enlargement of the first-direction size of the answer field 10 can be achieved only by increasing the input value for the input field 703 in the setting screen 700.

Also in the first embodiment, as described above, for determination of the answer-field character count, the image processing section 113 uses a margin number accepted by the operation panel 7. With this constitution, since the first-direction size adjustment (change in margin number) of the answer field 10 can be easily done, convenience for question-preparing persons is improved. For example, enlargement of the first-direction size of the answer field 10 can be achieved only by increasing the input value for the input field 701 in the setting screen 700. In addition, this is also the case with a second embodiment.

Also in the first embodiment, as described above, the larger the character size of characters accepted by the operation panel 7 is, the larger the second-direction size of the answer field 10 is made by the image processing section 113. With this constitution, since the second-direction size adjustment (change in character size) of the answer field 10 can be easily done, convenience for question-preparing persons is improved. For example, enlargement of the second-direction size of the answer field 10 can be achieved only by increasing the input value for the input field 702 in the setting screen 700. In addition, this is also the case with the second embodiment.

Also in the first embodiment, as described above, for conversion of the marking area 8 to the answer field 10, the image processing section 113 makes a distance between images present at preceding and succeeding places of the marking area 8 in the first direction larger than a current distance and moreover makes a distance between images present at preceding and succeeding places of the marking area 8 in the second direction larger than a current distance. As a result of this, event though the size of the answer field 10 is enlarged relative to the size of the marking area 8, the answer field 10 never overlaps with any other image. In addition, this is also the case with the second embodiment.

### Second Embodiment

In the second embodiment, for generation of image data of fill-in-blank questions, the image processing section 113 discriminates marking areas 8 present in object image data D1, as in the first embodiment.

Upon discrimination of a marking area 8, the image processing section 113 perform a labeling process for the marking area 8. By this process, the image processing section 113 determines a number of pixel blocks (blocks of pixels having a pixel value of a predetermined threshold or more) present in the marking area 8. That is, the image processing section 113 acquires a label count obtained by performing the labeling process for the marking area 8. Then, the image processing section 113 recognizes the determined number of pixel blocks (label count) as the character count of the marking area 8.

For example, in the example shown in FIG. 5, when the labeling process for the marking area 8a inclusive of the character string CS1 has been performed by the image processing section 113, label numbers are assigned to individual pixel blocks (individual character images) present in a plurality of areas encircled by solid-line circular frames, respectively, as shown in FIG. 6. That is, the label count is ‘3’. Thus, the image processing section 113 recognizes the character count of the marking area 8a as ‘3’.

Also in the example shown in FIG. 5, when the labeling process for the marking area 8b inclusive of the character string CS2 has been performed by the image processing section 113, label numbers are assigned to individual pixel blocks (character images) present in a plurality of areas encircled by solid-line circular frames, respectively, as shown in FIG. 7. That is, the label count is ‘4’. Therefore, the image processing section 113 recognizes the character count of the marking area 8b as ‘4’.

Depending on the type of characters or the setting of the threshold for binarization of the object image data D1, a plurality of label numbers may be assigned to a character image per character. For example, with regard to the character image of the character C13 in the marking area 8a, the character image per character may be classified into a left-side pixel block and a right-side pixel block, where different label numbers may be assigned to the pixel blocks, respectively. Similarly, also with regard to the character image of the character C11 in the marking area 8a as well as the character image of the character C24 in the marking area 8b, there are cases in which a character image per character is classified into a plurality of pixel blocks. As a result, the character count of the marking area 8 recognized by the image processing section 113 becomes larger than the actual character count of the marking area 8. In the following description, it is assumed, for convenience' sake, that a single label number is assigned to a character image per character.

Also, for an adjacent-to-marking area 9, which is one (upper-side one) of both-side areas of a marking area 8 in the second direction and which is adjacent to the marking area 8, the image processing section 113 performs a labeling process similar to the labeling process performed for the marking areas 8 (i.e., the image processing section 113 determines a number of pixel blocks present in the adjacent-to-marking area 9).

For example, as shown in FIG. 7, kana characters are added to the characters C21 and C22 of the marking area 8b. In other words, pixel blocks are present in the adjacent-to-marking area 9b. In this case, the image processing section 113 recognizes, as a character count, a number of pixel blocks (portions encircled by broken-line circular frames) present in the adjacent-to-marking area 9b. The character count of the adjacent-to-marking area 9b recognized by the image processing section 113 is ‘6’.

As shown in FIG. 6, on the other hand, no kana characters are added to the character string of the marking area 8a (i.e., no pixel blocks are present in the adjacent-to-marking area 9a). Therefore, the image processing section 113 recognizes the character count of the adjacent-to-marking area 9a as ‘0’.

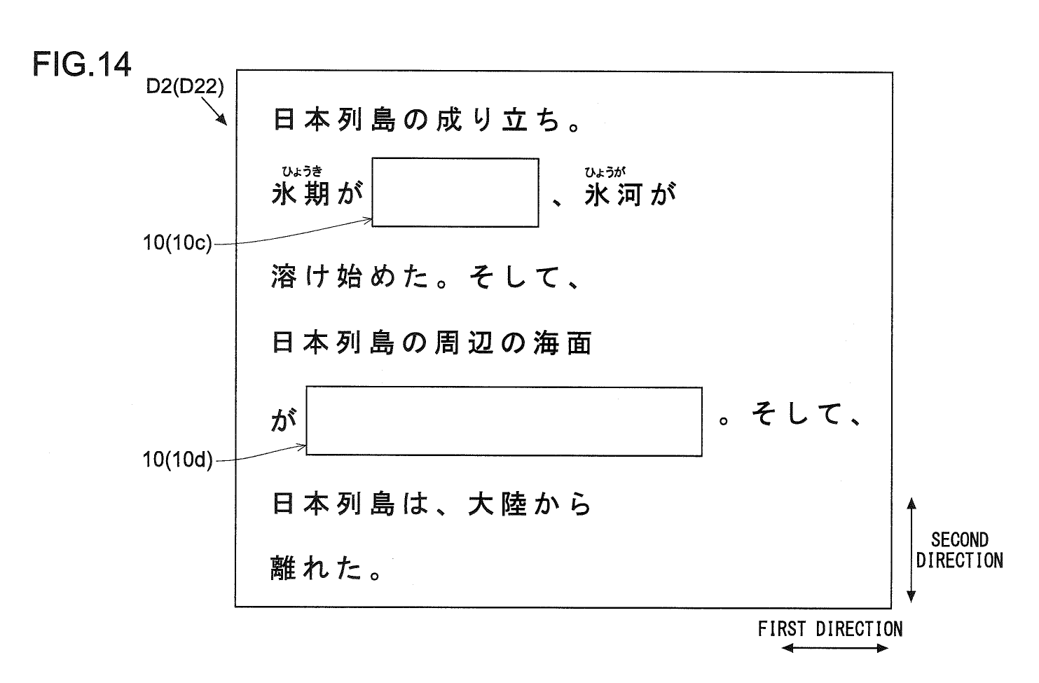

After executing the labeling process (after recognizing character counts of the marking area 8 and the adjacent-to-marking area 9), the image processing section 113 generates such image data D2 (D22) of fill-in-blank questions as shown in FIG. 14. The image data D22 of fill-in-blank questions is image data in which the marking areas 8 of the object image data D1 shown in FIG. 5 have been converted to blank answer fields 10. More specifically, the images of the marking areas 8 are erased and internally-blanked frame images are inserted instead. In this process, the images of the adjacent-to-marking areas 9 are also erased. Hereinafter, an answer field 10 corresponding to the marking area 8a will be designated by sign 10c, and an answer field 10 corresponding to the marking area 8b will be designated by sign 10d.

For generation of the image data D22 of fill-in-blank questions, the image processing section 113 determines an answer-field character count resulting from adding a margin to a predicted character count that could be entered into the answer field 10. The answer-field character count is a character count resulting from adding a margin number to a total sum of a character count of the marking area 8 and a character count of the adjacent-to-marking area 9.

For example, it is assumed that the margin number set in the setting screen 700 (see FIG. 4) is ‘2’. In this case, since the character count of the marking area 8a is ‘3’ and the character count of the adjacent-to-marking area 9a is ‘0’, the answer-field character count of the answer field 10a results in ‘5 (=3+0+2)’. Also, since the character count of the marking area 8b is ‘4’ and the character count of the adjacent-to-marking area 9b is ‘6’, the answer-field character count of the answer field 10b results in ‘12(=4+6+2)’.

Then, as shown in FIG. 9, in converting the marking area 8 to the answer field 10, the image processing section 113 makes the first-direction size of the answer field 10 larger than the first-direction size of the marking area 8. Further, the image processing section 113 makes the second-direction size of the answer field 10 larger than the second-direction size of the marking area 8. The process executed in this case is the same as in the first embodiment.

Also, for conversion of the marking area 8 to the answer field 10, as shown in FIG. 10, in order that a first image 80A and a second image 80B present at preceding and succeeding places of the marking area 8 in the first direction are prevented from overlapping with the answer field 10, the image processing section 113 enlarges a distance L1 between the first image 80A and the second image 80B. The process executed in this case is the same as in the first embodiment.

Further, as shown in FIG. 11, in order that a third image 80C and a fourth image 80D present at preceding and succeeding places of the marking area 8 in the second direction are prevented from overlapping with the answer field 10, the image processing section 113 enlarges a distance L2 between the third image 80C and the fourth image 80D. The process executed in this case is the same as in the first embodiment.

As a result of this, such image data D22 of fill-in-blank questions as shown in FIG. 14 is generated. The image data D2 of fill-in-blank questions is outputted to the printing section 2.

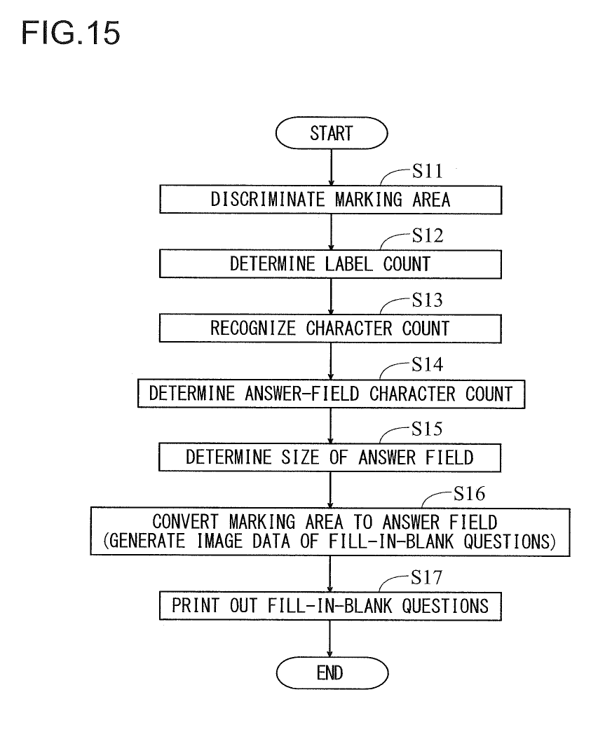

Hereinbelow, a processing flow for generation of the image data D22 of fill-in-blank questions will be described with reference to the flowchart shown in FIG. 15. With the object image data D1 (image data of an original serving as a base of fill-in-blank questions) transferred to the image processing section 113, when the control section 110 has issued a command for preparation of the image data D22 of fill-in-blank questions to the image processing section 113, the flowchart shown in FIG. 15 gets started.

At step S11, the image processing section 113 discriminates a marking area 8 out of the object image data D1. Subsequently at step S12, the image processing section 113 performs a labeling process for the marking area 8 and an adjacent-to-marking area 9. As a result of this, the image processing section 113 determines a number of pixel blocks (label count) of the marking area 8 and also determines a number of pixel blocks (label count) of the adjacent-to-marking area 9. Then, at step S13, the image processing section 113 recognizes the label count of the marking area 8 as a character count of the marking area 8 (number of characters present in the marking area 8), and moreover recognizes the label count of the adjacent-to-marking area 9 as a character count of the adjacent-to-marking area 9 (number of characters present in the adjacent-to-marking area 9).

At step S14, the image processing section 113 sums up the character count of the marking area 8 and the character count of the adjacent-to-marking area 9 and then adds the margin number to the summed-up total value to determine the resulting character count as an answer-field character count. Thereafter, at step S15, the image processing section 113 determines the size of the answer field 10 on a basis of the answer-field character count and the character size set in the setting screen 700 (see FIG. 4).

At step S16, the image processing section 113 converts the marking area 8 of the object image data D1 to the answer field 10. Thus, the image data D22 of fill-in-blank questions is generated. Then, at step S17, the image processing section 113 outputs the image data D22 of fill-in-blank questions (exposure control-dedicated data) to the printing section 2. The printing section 2, having received the image data D22, prints out the fill-in-blank questions on a sheet and delivers the sheet.

In the second embodiment, the first-direction size of the answer field 10 is changed to a size adapted to the answer-field character count. In this case, since the answer-field character count is a character count resulting from adding the margin number to the character count of the marking area 8, the answer-field character count becomes larger than the character count of the marking area 8. Therefore, the first-direction size of the answer field 10, when changed to a size adapted to the answer-field character count, becomes larger than the first-direction size of the marking area 8. In other words, the first-direction size of the answer field 10 never becomes equal to or smaller than the first-direction size of the marking area 8. As a result of this, there can be suppressed occurrence of a disadvantage that characters can hardly be entered into the answer field 10 due to an excessively small size of the answer field 10 on the fill-in-blank question sheet printed on a basis of the fill-in-blank question image data D2, as in the first embodiment.

Also in the second embodiment, as described above, the image processing section 113 performs the labeling process for an adjacent-to-marking area 9 which is one of both-side areas of the marking area 8 in the second direction perpendicular to the first direction and which is adjacent to the marking area 8. With pixel blocks present in the adjacent-to-marking area 9, the image processing section 113 recognizes a number of pixel blocks present in the adjacent-to-marking area 9 as its character count, and determines, as an answer-field character count, a character count resulting from adding the margin number to a total sum of the character count of the marking area 8 and the character count of the adjacent-to-marking area 9. According to this constitution, with kana-added kanji characters marked as an example, since the kana count (character count) of kana characters added to the kana-added kanji characters is added to the answer-field character count, the first-direction size of the answer field 10 becomes even larger (the larger the character count of kana characters is, the larger the first-direction size of the answer field 10 becomes). Thus, there can be suppressed occurrence of a disadvantage that the answer field 10 lacks entry space for entry of hiragana characters corresponding to kana-added kanji characters.

The embodiment disclosed herein should be construed as not being limitative but being an exemplification at all points. The scope of the disclosure is defined not by the above description of the embodiment but by the appended claims, including all changes and modifications equivalent in sense and range to the claims.

What is claimed is:

1. An image processing apparatus comprising:
an input section for inputting image data of an original inclusive of a document to the image processing apparatus; and
an image processing section for discriminating a marking area marked by a user out of image data of the original and generating image data of fill-in-blank questions with the marking area converted to a blank answer field, wherein p1 for generation of the image data of fill-in-blank questions, the image processing section performs a character recognition process for character recognition of the marking area to recognize a character count of characters present in the marking area, determines, as an answer-field character count, a character count resulting from adding a margin number to the character count of the marking area, and changes a size of the answer field in a first direction, which is a direction in which writing of the document progresses, to a size adapted to the answer-field character count.

2. The image processing apparatus according to claim 1, wherein
the image processing section classifies the characters of the marking area into kanji characters and non-kanji characters and performs the character recognition process for an adjacent-to-marking area, which is one of both-side areas of the marking area in a second direction perpendicular to the first direction and which is adjacent to the marking area, to thereby recognize kana characters added to the kanji characters of the marking area, whereby the image processing section further classifies the kanji characters of the marking area into kana-added kanji characters, which are kanji characters with phonetic-aid kana characters added thereto, and no-kana-added kanji characters, which are kanji characters with no phonetic-aid kana characters added thereto, and determines, as the answer-field character count, a character count resulting from adding the margin number to a total sum of a kana count of kana characters of the kana-added kanji characters, a character count of the no-kana-added kanji characters, and a character count of the non-kanji characters.

3. The image processing apparatus according to claim 2, wherein
for determination of the answer-field character count, the image processing section multiplies a character count of the no-kana-added kanji characters by a predetermined weighting factor.

4. The image processing apparatus according to claim 3, further comprising
an accepting part for accepting a setting of the weighting factor from a user, wherein
for determination of the answer-field character count, the image processing section multiplies a character count of the no-kana-added kanji characters by the weighting factor accepted by the accepting part.

5. The image processing apparatus according to claim 1, further comprising
an accepting part for accepting a setting of the margin number from a user, wherein
for determination of the answer-field character count, the image processing section uses the margin number accepted by the accepting part.

6. The image processing apparatus according to claim 1, further comprising
an accepting part for accepting a setting of character size from a user, wherein
the larger the character size accepted by the accepting part is, the larger the size of the answer field in a second direction perpendicular to the first direction is made by the image processing section.

7. The image processing apparatus according to claim 1, wherein
for conversion of the marking area to the answer field, the image processing section makes a distance between images present at preceding and succeeding places of the marking area in the first direction larger than its current distance and moreover enlarges a distance between images present at preceding and succeeding places of the marking area in a second direction perpendicular to the first direction larger than its current distance.

8. The image processing apparatus according to claim 1, further comprising
a printing section for performing printing process on a basis of the image data of fill-in-blank questions generated by the image processing section.

9. An image processing apparatus comprising:
an input section for inputting image data of an original inclusive of a document to the image processing apparatus; and
an image processing section for discriminating a marking area marked by a user out of image data of the original and generating image data of fill-in-blank questions with the marking area converted to a blank answer field, wherein
for generation of the image data of fill-in-blank questions, the image processing section performs a labeling process for the marking area to determine a number of pixel blocks that are blocks of pixels having a pixel value equal to or higher than a predetermined threshold, and moreover recognizes the determined number of pixel blocks as a character count of the marking area, determines, as an answer-field character count, a character count resulting from adding a margin number to the character count of the marking area, and changes a size of the answer field in a first direction, which is a direction in which writing of the document progresses, to a size adapted to the answer-field character count.

10. The image processing apparatus according to claim 9, wherein
the image processing section performs the labeling process for an adjacent-to-marking area, which is one of both-side areas of the marking area in a second direction perpendicular to the first direction and which is adjacent to the marking area, whereby with the pixel blocks present in the adjacent-to-marking area, the image processing section recognizes, as a character count, a number of the pixel blocks present in the adjacent-to-marking area, and determines, as the answer-field character count, a character count resulting from adding the margin number to a total sum of a character count of the marking area and a character count of the adjacent-to-marking area.

11. The image processing apparatus according to claim 9, further comprising
an accepting part for accepting a setting of the margin number from a user, wherein
for determination of the answer-field character count, the image processing section uses the margin number accepted by the accepting part.

12. The image processing apparatus according to claim 9, further comprising
an accepting part for accepting a setting of character size from a user, wherein
the larger the character size accepted by the accepting part is, the larger the size of the answer field in a second direction perpendicular to the first direction is made by the image processing section.

13. The image processing apparatus according to claim 9, wherein
for conversion of the marking area to the answer field, the image processing section makes a distance between images present at preceding and succeeding places of the marking area in the first direction larger than its current distance and moreover makes a distance between images present at preceding and succeeding places of the marking area in a second direction perpendicular to the first direction larger than its current distance.

14. The image processing apparatus according to claim 9, further comprising
a printing section for performing printing process on a basis of the image data of fill-in-blank questions generated by the image processing section.
